(19) United States
(12) Patent Application Publication
(10) Pub. No.: US 2013/0149984 A1
(43) Pub. Date: Jun. 13, 2013

(54) Disaster Alert Warning Network

(71) Applicant: Dominique Tomlinson, Crescent City, CA (US)

(72) Inventor: Dominique Tomlinson, Crescent City, CA (US)

(21) Appl. No.: 13/314,899

(22) Filed: Dec. 8, 2011

(51) Int. Cl. H04W 4/22

(52) U.S. Cl. 455/404.1

(57) ABSTRACT

An emergency alert network for alerting users of hazardous weather conditions comprising: a cellular network; a database connected to the cellular network, where the database stores user data; a plurality of users; and a central communication center connected to the network, where the central communications center transmits alerts and warnings to a selected group of users. The user data may include a cellular phone number or other identifying data. The alerts and warnings generally relate to hazardous weather conditions. The communication center may be a local weather bureau, a fire department or an emergency response center.

### BACKGROUND OF THE INVENTION

1. Field of Invention

The present invention leads to a warning alert network that provides alerts to individuals of hazardous or unsafe weather conditions.

2. Description of Related Art

Warning systems have been implemented to alert the public of imminent adverse and hazardous weather conditions that may be in particular areas. Many of these weather alert systems involve broadcasts over television and radio communication systems. It is well known that it is imperative to alert the public of oncoming hazardous weather conditions. Early warnings have been found to be particularly effective in the case of hurricanes and in some cases, tsunamis. The alert systems ensure that the public is able to evacuate a particular area and to retreat to safe areas to avoid the consequences of the particular weather conditions. Warnings are also necessary for tornadoes and severely high winds that may potentially cause significant damage. Other than broadcasting over television and the radio network, warnings may be signaled through the use of emergency horns or sirens within a particular city. However, a more effective warning system may include warnings transmitted over a cellular network. Cell phones are very prevalent in today's society and people have the ability to receive voice and data messaging through the use of their cell phones. Consequently, if the individuals were able to join a warning alert network linked to each cellular phone numbers, an emergency warning system could be instituted for use over a cellular network.

### SUMMARY OF THE INVENTION

The present invention relates to an emergency alert network for alerting users of hazardous weather conditions comprising: a cellular network; a database connected to the cellular network, where the database stores user data; a plurality of users; and a central communication center connected to the network, where the central communications center transmits alerts and warnings to a selected group of users. The user data may include a cellular phone number or other identifying data. The alerts and warnings generally relate to hazardous weather conditions. The communication center may be a local weather bureau, a fire department or an emergency response center.

### BRIEF DESCRIPTION OF DRAWINGS

FIG. 1 depicts a cellular warning network system in accordance with the present invention.

### DETAILED DESCRIPTION

The present invention is an emergency warning system and method for broadcasts over cellular networks. A user of the emergency warning system, according to the present invention shares their cellular communication number with a central communication center. This central communication center then transmits emergency alerts warnings and alerts to the members of the network system. This emergency warning system enables the local authorities to transmit alerts to the users who have enlisted in the Emergency Alert Network System.

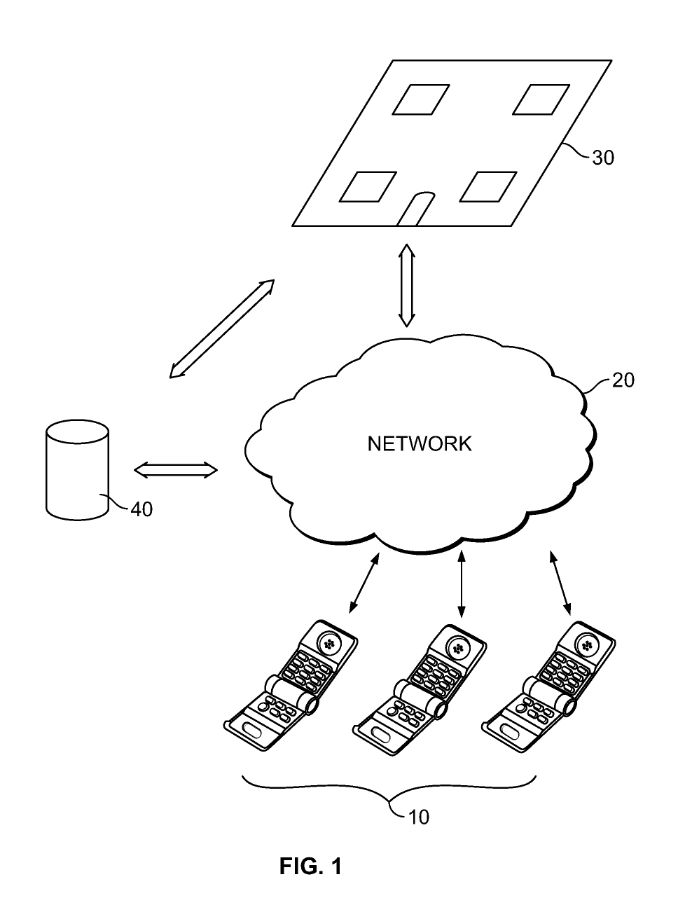

In reference to FIG. 1, a depiction of the Emergency Alert Network System according to the present invention is that depicted. A network 20 is provided which connects with a plurality of users 10. The plurality of user's cellular data is stored on a database of 40. A central communication center 30 is provided to transmit emergency alerts to user's cell phones, whose identification is stored on the database of 40. The database 40 stores exclusively the cell phone numbers of the users and limits the amount of data stored that may be accessed by an emergency authority. The central communication center 30 may be a local weather bureau, a fire department or emergency response center. The system enables the transmission of a warning or alert to each user. This critical information is transmitted in the form of data such as a SMS message and is transmitted to the user's cell phone. Further recorded voice alerts may also be transmitted to the users. The cellular warning network may be expanded to various areas so that the user may be contacted when travelling to different locations. Consequently, if a user is originally from California and maybe visiting Florida, the user's cell phone is identified in Florida and it may be available for emergency alerts while visiting Florida. Conversely, the user may also receive emergency alerts when in California. This methodology of warning alerts, therefore, is interchangeable based upon the region and location of an individual's cellular phone.

Officials at the various locations of the warning network are aware that a user was in a particular location based upon user's connection to a local cellular base station. The base station helps to identify the individual's cellular number and therefore, make that user available for the reception of any emergency alerts or warnings. The instant invention has been shown and described in what it considers to be the most practical and preferred embodiments. It is recognized, however, that departures may be made there from within the scope of the invention and that obvious modifications will occur to a person skilled in the art.

What is claimed is:

1. An emergency alert network for alerting users of hazardous weather conditions comprising:
a. a cellular network;
b. a database connected to the cellular network, where the database stores user data;
c. a plurality of users; and
d. a central communication center connected to the network, where the central communications center transmits alerts and warnings to a selected group of users.

2. The emergency alert network according to claim 1, where the user data includes a cellular phone number.

3. The emergency alert network according to claim 1, where the alerts and warnings relate to hazardous weather conditions.

4. The emergency alert network according to claim 1, where the communication center is at least one of a local weather bureau, a fire department and an emergency response center.

5. A method of transmitting alerts and warnings over a cellular network comprising the steps of:
a. storing a plurality of user cellular contact data on a database;
b. connecting the database to the cellular network;
c. transmitting user cellular contact data to a central communications center; and
d. transmitting alerts and warnings from the central communications center.

6. The method of transmitting alerts and warnings according to claim 5, further including the step of identifying users within an affected area and transmitting the alerts and warnings to users within the affected area.
